(19) United States
(12) Patent Application Publication
(10) Pub. No.: US 2022/0105427 A1
(43) Pub. Date: Apr. 7, 2022

(54) GAME CONTROL METHOD, COMPUTER-READABLE STORAGE MEDIUM, SERVER AND COMMUNICATION DEVICE

(71) Applicants: NHN Corporation, Seongnam-si (KR); NHN PlayArt Corp., Tokyo (JP)

(72) Inventor: Tomoyuki HAYASHI, Tokyo (JP)

(21) Appl. No.: 17/490,333

(22) Filed: Sep. 30, 2021

(30) Foreign Application Priority Data
Oct. 1, 2020 (JP) 2020-167224

(51) Int. Cl. A63F 13/2145; A63F 13/426; A63F 13/577; A63F 13/837

(52) U.S. Cl. CPC A63F 13/2145; A63F 13/426; A63F 2300/8076; A63F 13/837; A63F 2300/1075; A63F 13/577

(57) ABSTRACT

A game control method includes making a first object to be operated perform a preparatory action for an attack action, triggered by an input from a long press operation on a screen; and making the first object perform the attack action against a second object when the second object to be attacked satisfies a first condition while the first object is performing the preparatory action.

### CROSS REFERENCE TO RELATED APPLICATIONS

This application is based on and claims the benefit of priority from the prior Japanese Patent Application No. 2020-167224, filed on Oct. 1, 2020, the entire contents of which are incorporated herein by reference.

### FIELD

One embodiment of the present invention relates to a game control method and program for controlling objects in a screen.

### BACKGROUND

In recent years, various game programs executed on a portable terminal such as a smart phone have been distributed. When games are executed in a portable terminal, operations by the user are input using a touch panel. A command (instruction) for an object (also referred to as a player character) to be operated in a screen is input through a touch operation on the screen. For the touch operation, for example, a short tap operation (hereinafter referred to as a “tap operation”), a long tap operation (hereinafter referred to as a “long-press operation”), a slide operation, or the like is used.

In operation games, operations such as moving objects, aiming objects, etc. must be controlled in limited spaces within the screen. Therefore, the long-press operation on the screen is used as one of important operations that can be distinguished from a simple tap operation. For example, Japanese laid-open patent publication No. 2019-37783 describes that when a long-press operation is performed on a screen of a touch display, a virtual character performs a consecutive shooting action.

### SUMMARY

A game control method according to an embodiment of the present invention includes making a first object to be operated perform a preparatory action for an attack action, triggered by an input from a long-press operation on a screen; and making the first object perform the attack action against a second object when the second object to be attacked satisfies a first condition while the first object is performing the preparatory action.

The first object may move in a direction indicated by a slide operation maintaining the preparatory action when an input from a slide operation against the screen is acquired while the first object is performing the preparatory action.

The first condition may be that the second object is located inside an attack area of the first object.

The first condition may be that the second object overlaps a sight region displayed on the screen.

The first object may perform the preparatory action without making the first object perform the attack action when the second object satisfies the first condition and the first object satisfies a second condition.

The action of the first object may be shifted from the attack action to the preparatory action when the first object satisfies the second condition while the first object is performing the attack action.

Information indicating that the second condition is satisfied may be displayed on the screen when the first object satisfies the second condition.

The second condition may be that there is a factor preventing the first object from attacking the second object.

The second condition may be that the first object and the second object are separated by more than a predetermined distance.

The preparatory action may be holding a weapon. The attack action may be an action of releasing an attack medium from the weapon.

A collision detection area of the second object against the attack medium may be larger than an occupied area of the second object.

A collision detection area of the second object against the attack medium may be approximately equal to an occupied area of the second object in a first communication state, and larger than the occupied area of the second object in a second communication state with a communication speed lower than the first communication state.

An identification image may be displayed on a position of a contact point where the long-press operation was initiated in response to an input by the long-press operation.

A computer-readable storage medium storing a program in an embodiment of the present invention may stores a program for causing a control part of a server or communication device to execute the game control method described above.

A server or a communication device includes a control part for executing the game control method described above.

According to an embodiment of the present invention, it is possible to prevent a player character from performing unnecessary attack action while maintaining the attack posture of the player character.

### BRIEF DESCRIPTION OF THE DRAWINGS

FIG. 1 shows a block diagram of a configuration of a communication system in a first embodiment of the present invention;

FIG. 2 shows a block diagram of a configuration of a communication device in the first embodiment of the present invention;

FIG. 3 shows a block diagram of a configuration of a server in the first embodiment of the present invention;

FIG. 4 shows a configuration of a game screen in the first embodiment of the present invention;

FIG. 5 shows a state in which a long-press operation is performed on the game screen in the first embodiment of the present invention;

FIG. 6 shows a state in which a long-press operation is performed on the game screen in the first embodiment of the present invention;

FIG. 7 shows a state in which a slide operation is performed while maintaining the long-press operation on the game screen in the first embodiment of the present invention;

FIG. 8 shows a state in which a player character image is stopped moving while maintaining the long-press operation on the game screen in the first embodiment of the present invention;

FIG. 9 shows a flowchart diagram for explaining the processing of an attack action in the first embodiment of the present invention;

FIG. 10 shows a state in which a long-press operation is performed on a game screen in a second embodiment of the present invention;

FIG. 11 shows a state in which a slide operation is performed while maintaining a long-press operation on a game screen in a third embodiment of the present invention;

FIG. 12 shows a state in which a player character image is stopped moving while maintaining the long-press operation on the game screen in the third embodiment of the present invention;

FIG. 13 shows a state in which a long-press operation is performed on a game screen in a fourth embodiment of the present invention; and

FIG. 14 shows a state in which a sight region overlaps on an enemy character image in the game screen in the fourth embodiment of the present invention.

### DESCRIPTION OF EMBODIMENTS

In the technique described in the above-mentioned prior art, although a continuous shooting action can be realized by a simple operation of performing a long-press operation on a screen, while the long-press operation is continued, the shooting action is performed regardless of the presence or absence of an attack target (for example, an enemy character). Such an unnecessary shooting action may cause problems, for example, wastage of ammunition or deterioration of visibility of screens due to constantly fired bullets.

One of the objects of an embodiment of the present invention is to prevent an unnecessary attack action from being executed while maintaining an attack posture of a player character.

Hereinafter, an image control method (a method for controlling game progress), which is an embodiment of the present invention, will be described with reference to the drawings. However, the present invention can be implemented in many different aspects. That is, the present invention is not construed as being limited to the description of the following embodiments. In the drawings referred to in this embodiment, the same portions or portions having the same functions are denoted by the same reference numerals or the same reference numerals followed by an alphabet, and repetitive description thereof is omitted.

In this specification and claims, the terms are defined as follows.

“Object” means an image representing an object to be manipulated or processed on a computer. For example, a player character image that is an operation target of a user in a game screen is an “object to be operated”.

“Touch operation” refers to an operation performed by the user by touching a touch panel or the like on the game screen with a finger, a stylus pen, or the like (hereinafter, referred to as an “instruction object”). “Tap operation” refers to a touch operation in which the period from the start of the contact of the instruction object to the release is short. “Long-press operation” refers to a touch operation in which the period from the start of the contact of the instruction object to the release is longer than the tap operation. “Slide operation” refers to an operation of moving the contact point while maintaining the contact state of the instruction object. The slide operation is also called a swipe operation.

“Program” refers to an instruction or set of instructions executed by a processor in a computer having a processor and a memory. “Computer” is a generic term that refers to an executing entity of a program. For example, when a program is executed by a server (or client), “computer” refers to the server (or client). When a “program” is executed by distributed processing between the server and the client, the “computer” includes both the server and the client. In this case, the “program” includes the “program executed on the server” and the “program executed on the client”. Similarly, when a “program” is distributed among multiple servers, the “computer” includes the multiple servers, and the “program” includes each program executed at each server.

### First Embodiment

### Configuration of Communication System

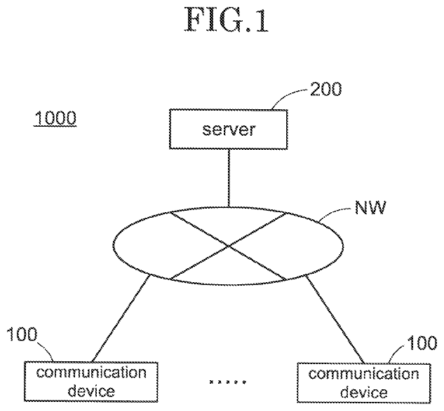

FIG. 1 is a block diagram showing a configuration of a communication system 1000 according to a first embodiment of the present invention. The communication system 1000 includes a communication device 100 and a server 200. The communication device 100 and the server 200 are connected to a network NW, such as the Internet or a communication line. The communication system 1000 is a client-server system consisting of the communication device 100 as a client and the server 200.

The communication device 100 is, for example, a portable terminal such as a smart phone. The communication device 100 can communicate with the server 200 or other communication devices by connecting to the network NW. The communication device 100 may install a game program. By executing a game program installed in the communication device 100, a game in which an object such as a character in the game screen can be operated according to a user's operation is provided.

The game program is downloaded from the server 200 via the network NW to the communication device 100. However, the game program may be installed in the communication device 100 in advance. Further, the game program may be provided in a state of being recorded on a computer-readable recording medium such as a magnetic recording medium, an optical recording medium, a magneto-optical recording medium, a semiconductor memory, or the like. In this case, the communication device 100 may be an information processing device having a device for reading a recording medium.

The game program may be executed by the communication device 100, by the server 200, or by the communication device 100 and the server 200 in which the roles are shared and executed (so-called distributed processing is performed).

The server 200 is an information processing device that provides a game program or various services to the communication device 100. Various services include, for example, login processing, synchronization processing, and the like in executing an on-line game in the communication device 100. In addition, various services may include, for example, social networking services (SNS). The game program is recorded in a memory device included in the server 200, a recording medium readable by the server 200, or a database in which the server 200 can be connected via the network NW. In FIG. 1, the server 200 is illustrated as a single information processing device, but may be configured by a plurality of information processing devices.

### Configuration of Communication Device

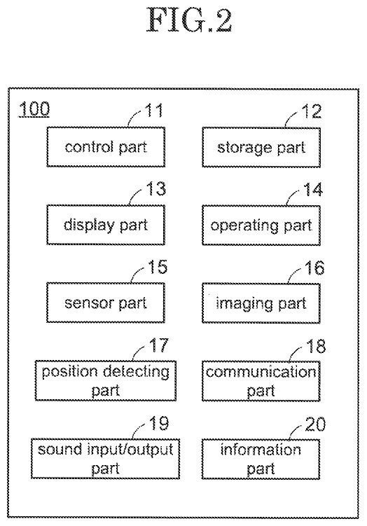

FIG. 2 is a block diagram showing a configuration of the communication device 100 according to the first embodiment of the present invention. The communication device 100 of the present embodiment includes a control part 11, a storage part 12, display part 13, an operating part 14, a sensor part 15, an imaging part 16, a position detecting part 17, a communication part 18, a sound input/output part 19, and an information part 20. However, the communication device 100 is not limited to including all of these elements.

The control part 11 includes a processor (calculation processing device) such as a CPU (Central Processing Part) and a memory device such as RAM. The control part 11 executes a program stored in the storage part 12 by a processor to realize various functions in the communication device 100. Signals output from each element of the communication device 100 are used by various functions implemented in the communication device 100.

The storage part 12 is a recording device (recording medium) capable of permanently holding information such as a non-volatile memory or a hard disk drive and rewriting information. The storage part 12 stores a program and parameters required to execute the program. For example, the game program described above is stored in the storage part 12. The storage part 12 may be a computer-readable recording medium (e.g., portable memory).

The display part 13 has a display area for displaying various screens (e.g., game screens) under the control of the control part 11. The display part 13 is, for example, a display device such as a liquid crystal display or an organic EL display.

The operating part 14 is an operating device for outputting a signal corresponding to the user's operation (e.g., a signal indicating a command or information) to the control part 11. The operating part 14 is a touch sensor arranged on the surface of the display part 13. The operating part 14 constitutes a touch panel by combining with the display part 13. Instructions or information corresponding to user's operations are input to the communication device 100 by touching the operating part 14 with the instruction object such as a finger of the user or a stylus pen. However, the operating part 14 may include a switch arranged on a housing of the communication device 100.

The sensor part 15 is a device having a function of collecting information about the movement of the communication device 100, an environment around the communication device 100 and converting the information into a signal. The sensor part 15 of the present embodiment is, for example, an acceleration sensor. The control part 11 acquires information about the movement of the communication device 100 (e.g., tilt, vibrates, etc.) based on an output signal of the sensor part 15. However, the sensor part 15 may include an illuminance sensor, a temperature sensor, a magnetic sensor, or the like.

The imaging part 16 is an imaging device (camera) for converting an image of an imaging target into a signal. The communication device 100 generates an image file (including a still image file and a moving image file) based on an imaging signal output from the imaging part 16. The imaging part 16 also functions as a scanner for reading an identification code such as a one-dimensional code or a two-dimensional code.

The position detecting part 17 detects a position of the communication device 100 based on location information. The position detecting part 17 detects the position of the communication device 100 using GNSS (Global Navigation Satellite System).

The communication part 18 is connected to the network NW under the control of the control part 11 and is a wireless communication module for transmitting and receiving data to and from other communication devices such as the server 200 connected to the network NW. The communication part 18 may include communication modules for performing infra-red communication, short-range radio communication, and the like.

The sound input/output part 19 inputs and outputs sound. For example, a sound is input by a microphone of the sound input/output part 19. A sound is output by a speaker of the sound input/output part 19. The sound input/output part 19 can be used not only for communication with other communication devices but also for outputting sounds, sound effects, or the like that accompany collection of external sound or game progress.

The information part 20 informs the user of the state of the communication device 100 by a visual, auditory, or tactile method. Specifically, the information part 20 informs the user of the state of the communication device 100 using light, sound, or vibrate. For example, the information part 20 can notify the user of the presence or absence of communication with an external device by blinking a lamp or vibrating an entire housing. Vibration of the entire housing is performed by a vibrator of the information part 20. The information part 20 can also notify the user of the transition of the screen state or the like in accordance with the game progress. For example, the information part 20 can notify the user that the touch operation satisfies a predetermined condition using light, sound, or vibrate.

### Configuration of Server

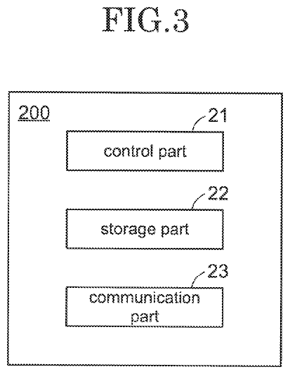

FIG. 3 is a block diagram showing a configuration of the server 200 according to the first embodiment of the present invention. The server 200 of the present embodiment includes a control part 21, a storage part 22, and a communication part 23.

The control part 21 includes a calculation processing circuit (control device) such as CPU and a memory device such as RAM. The control part 21 executes a program stored in the storage part 22 by the CPU to realize various functions in the server 200. Signals output from the respective components of the server 200 are used by various functions implemented in the server 200.

The storage part 22 is a recording device (recording medium) capable of permanently holding information such as a non-volatile memory or a hard disk drive and rewriting information. The storage part 22 stores a program and parameters required to execute the program. For example, the game program described above is stored in the storage part 22. The storage part 22 may be a computer-readable recording medium (e.g., portable memory). In addition, the storage part 22 stores various information received from another device (for example, the communication device 100) via the network NW.

The communication part 23 is connected to the network NW under the control of the control part 21, and is a wireless communication module for transmitting and receiving data to and from other devices such as the communication device 100 and other servers connected to the network NW. Examples of other servers include a game server, an SNS server, and a mail server.

### Configuration of Game Screen

A game screen GS (in other words, a game image) described below is displayed on the display part 13 of the communication device 100 by the control part 21 (specifically, a processor included in the control part 21) of the server 200 shown in FIG. 3 executing the game program read from the storage part 22. However, the control part 11 (specifically, a processor included in the control part 11) of the communication device 100 shown in FIG. 2 may execute the game program stored in the storage part 12 to display the game screen GS on its own display part 13.

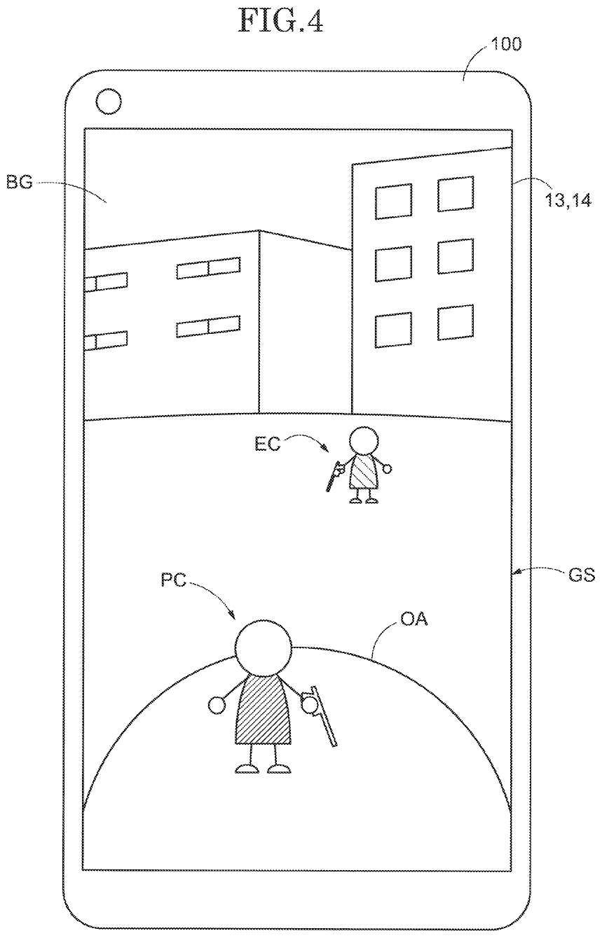

FIG. 4 is a diagram showing a configuration of the game screen GS in the first embodiment of the present invention. The communication device 100 is a portable terminal such as a smart phone. In this embodiment, it is assumed that a portable terminal is held with one hand (specifically, the right hand) and gaming operations are performed with one hand. The game screen GS is displayed on the display part 13 of the communication device 100. The touch sensor is arranged as the operating part 14 at approximately the same area as the display part 13.

The game screen GS shown in FIG. 4 includes a background image BG, a player character image PC, and an enemy character image EC. The background image BG is an image representing a background such as a ground, a building, or a sky. The player character image PC is an image representing an object (an object to be operated) operated by a user. The enemy character image EC is an image representing an object (an object not to be operated) operated by a computer or other user. The enemy character image EC can be said that is an object to be attacked because it is a target on which the player character image PC executes an attack. However, the game screen GS is merely an example, and the enemy character image EC may be omitted. That is, an object not to be operated, such as a building or a mobile object (e.g., a vehicle or an aircraft) may be an object to be attacked. As described above, the game screen GS is a screen visualizing a virtual space representing the game world. Specifically, an image captured by a virtual camera arranged at at least one point in the virtual space corresponds to the game screen GS.

As shown in FIG. 4, an operating area OA is set in advance in a lower portion of the game screen GS. In this embodiment, a substantially semicircular area is arranged as the operating area OA. If the operating area OA has an arcuate outer edge, it has the benefit of being easy to perform the slide operation described later in all directions. However, the present invention is not limited to this embodiment, and a circular, elliptical, or polygonal area may be arranged as the operating area OA. In this embodiment, the user performs the touch operation inside the operating area OA (in this embodiment, on the side where the player character images PC are located). However, not only the inside of the operating area OA but also the touch operation performed by the user on the outside of the operating area OA may also be accepted.

In this embodiment, since the operating area OA is provided within a reach of a thumb of a hand holding a portable terminal, the operation by the thumb of one hand is easy. This is because when the portable terminal is operated with one hand, the thumb of the hand holding the portable terminal is basically touched. Although in FIG. 4, an example of overlapping and displaying the player character image PC in the operating area OA has been shown, the player character image PC may be displayed without overlapping (or slightly overlapping) in the operating area OA. In this case, it is possible to avoid hiding the player character image PC with a finger during operation.

In this embodiment, the player character image PC is operated by inputting to the operating area OA by a touch operation. Specifically, the player character image PC is made to perform different operations according to the combination of the touch operation performed on the operating area OA. The following describes an example of making the player character image PC perform a shooting action as an attack action will be described. However, the attack action is not limited to this embodiment, and may include any operation as long as it is an operation that damages or changes the state of the enemy character. For example, the attack action may include an attack by a sword or spear, an attack by magic, the attack by an emission of energy waves, etc.

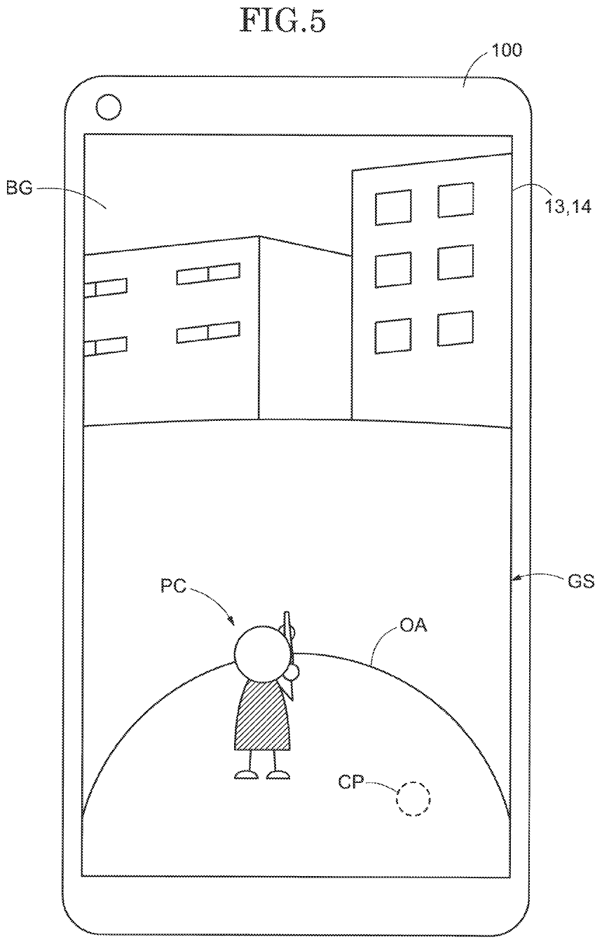

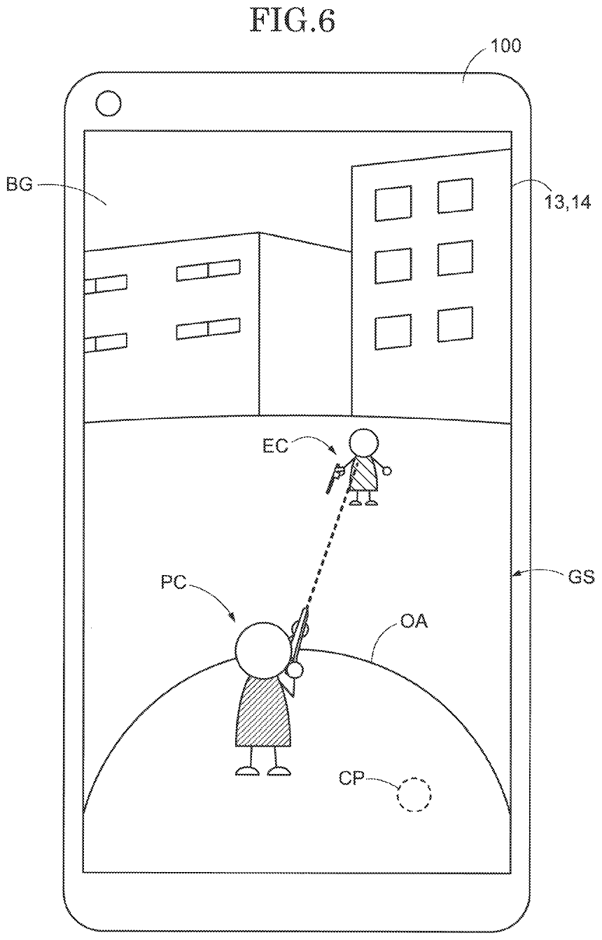

FIGS. 5 and 6 are diagrams showing a state in which a long-press operation is performed on the game screen GS according to the first embodiment of the present invention. Specifically, FIG. 5 shows a state in which an input by the long-press operation is performed when the enemy character EC does not exist in the game screen GS. FIG. 6 shows a state in which an input by the long-press operation is performed when the enemy character EC is present in the game screen GS. In FIGS. 5 and 6, a contact point CP indicated by a circle drawn by a chain line inside the operating area OA corresponds to a start point of the long-press operation. In this embodiment, since it is assumed that the long-press operation is performed with the user's fingers, the contact point CP is illustrated as an area occupying a certain area.

The presence or absence of the input by the long-press operation can be judged, for example, by whether a predetermined time has elapsed while maintaining the contact of the finger after the finger of the user contacts the contact point CP. That is, when a predetermined time has elapsed from the contact of the finger with the contact point CP, it is judged that the input is performed by the long-press operation. On the contrary, when the finger has left the screen before a predetermined time has elapsed, it is judged that the input is not the input by the long-press operation but a normal tap operation. In this embodiment, an example in which the contact of the finger with the screen is regarded as the touch operation is shown, but the present invention is not limited to this example. For example, it is also possible to judge that the touch operation has been made when the distance between the screen and the finger is a predetermined distance or less. In this case, it may be judged that the finger left the screen when the distance between the screen and the finger exceeds the predetermined distance.

As shown in FIG. 5, when there is no attack target (enemy character EC) in the game screen GS, and when the input is acquired by the long-press operation, the control part 21 of the server 200 makes the player character image PC execute a preparatory action of the attack action (in FIG. 5, the shooting action). More specifically, the player character image PC is displayed to hold a weapon (a gun in FIG. 5) in the hand and be in a shooting posture. In this embodiment, a state in which the player character image PC is in a shooting posture is sometimes referred to as an “attack mode”. That is, when the user performs the long-press operation on the inside of the operating area OA, the player character image PC transitions from a normal mode to the attack mode. In FIG. 5, since there is no attack target in the game screen GS, the player character image PC is in the shooting posture and stands by.

On the other hand, as shown in FIG. 6, when an attack target exists in the game screen GS, and when the control part 21 of the server 200 acquires the input by the long-press operation, the control part 21 of the server 200 makes the player character image PC to execute the attack action. More specifically, the player character image PC is in the shooting posture and releases an attack medium (a bullet in FIG. 6) from the weapon. That is, in FIG. 6, since the attack target exists in the game screen GS, the player character image PC performs an attack by shooting on the enemy character image EC.

Specifically, when the input is made by the long-press operation, the player character image PC in the game screen GS holds a gun. When the enemy character image EC is displayed on the game screen GS in a state in which the player character image PC holds the gun, the player character image PC attacks the enemy character image EC. In this case, the player character image PC automatically aims at the enemy character image EC and performs attacks to the enemy character image EC. Thus, the control part 21 of the server 200 makes the player character image PC execute the preparatory action of the attack action upon acquiring the input by the long-press operation. When the enemy character image EC is located in the game screen GS while the player character image PC is executing the preparatory action, the control part 21 makes the player character image PC execute the attack action on the enemy character image EC.

As described above, in this embodiment, when the enemy character image EC satisfies a predetermined condition (here, the enemy character image EC is located in the game screen GS) when the long-press operation is performed in the operating area OA, the player character image PC attacks the enemy character image EC (FIG. 6). However, when the enemy character image EC does not satisfy the above-mentioned predetermined condition, the player character image PC does not attack the enemy character image EC, and executes only the preparatory action (FIG. 5). That is, in this embodiment, even when the input is performed by the long-press operation in the operating area OA, the player character image PC does not execute the attack action unless the predetermined condition is satisfied. Therefore, if there is no enemy in the game screen GS and there is no need to perform the attack action, the player character image PC can stand by in the preparatory action.

Further, in this embodiment, the player character image PC can move within the game screen GS while maintaining the preparatory action. That is, the player character image PC can move back and forth and left and right in the virtual space while holding the gun. In this embodiment, the player character image PC can be moved by a slide operation on the game screen GS.

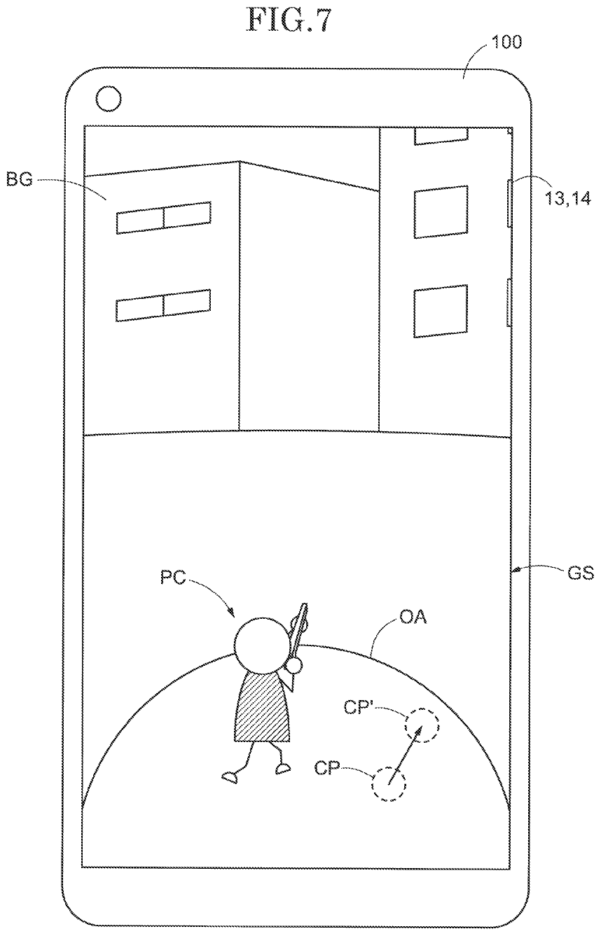

FIG. 7 is a diagram showing a state in which the slide operation is performed while maintaining the long-press operation on the game screen GS according to the first embodiment of the present invention. Specifically, FIG. 7 shows a state in which the player character image PC moves toward a building in front while holding a gun. In this embodiment, the player character image PC can be moved while maintaining the shooting posture by the slide operation (direction input operation) continuously performed from the long-press operation.

FIG. 7 shows a state in which the slide operation is performed toward another contact point CP′ at any position after the long-press operation is started at the contact point CP. In this embodiment, the player character image PC can be moved in the direction in which the finger is slid by performing the slide operation in any direction after performing the long-press operation. At this time, even when the slide operation straddles the inside of the operating area OA and the outside of the operating area OA, the player character image PC can be moved while maintaining the shooting posture.

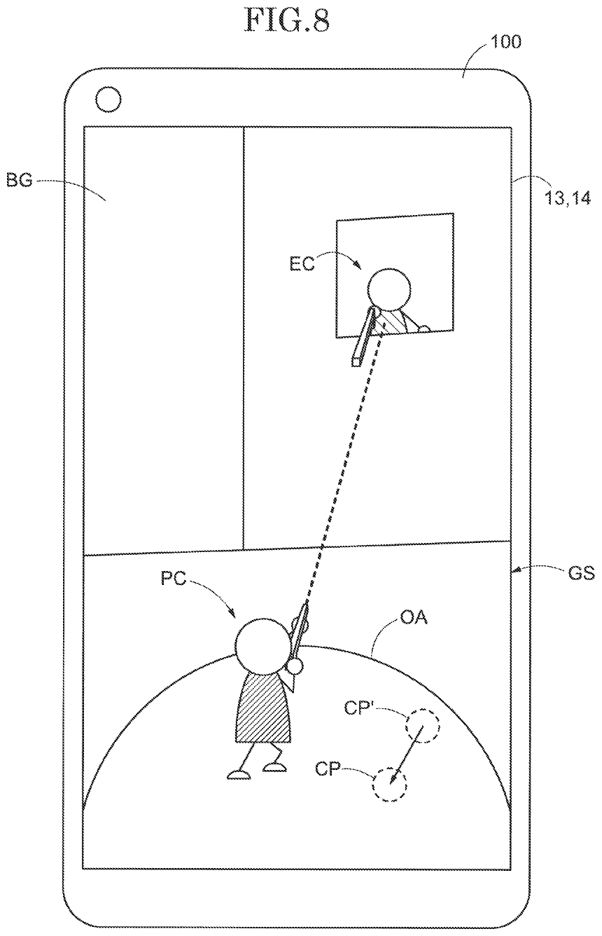

FIG. 8 is a diagram showing a state in which the player character image is stopped moving while maintaining the long-press operation on the game screen GS according to the first embodiment of the present invention. Specifically, FIG. 8 shows a state in which the player character image PC attacks the enemy character image EC appearing in the front building in a stopped state. In this embodiment, the movement of the player character image PC can be stopped while maintaining the shooting posture by returning the finger from a contact point CP′ to the original position of the contact point CP. However, the present invention is not limited to this example, and when the finger is released at the contact point CP′, the movement of the player character image PC may be stopped.

In the state shown in FIG. 7, the user continues the long-press operation on the game screen GS. That is, the player character image PC is moving while maintaining the attack mode. In this state, when the enemy character image EC appears in the game screen GS, the above-mentioned predetermined condition (that the enemy character image EC is located in the game screen GS) is satisfied. Therefore, the control part 21 of the server 200 automatically makes the player character image PC perform the attack action on the enemy character image EC. This state is the state shown in FIG. 8.

As described above, when the player character image PC is moving in the attack mode (that is, the state in which the preparatory action is executed by the user's long-press operation), if the enemy character image EC does not exist in the game screen GS, the player character image PC does not execute the attack action. On the other hand, when the enemy character image EC appears in the game screen GS while the player character image PC is moving in the attack mode, the player character image PC automatically executes the attack action on the enemy character image EC.

### Explanation of Processing Related to Attack Action

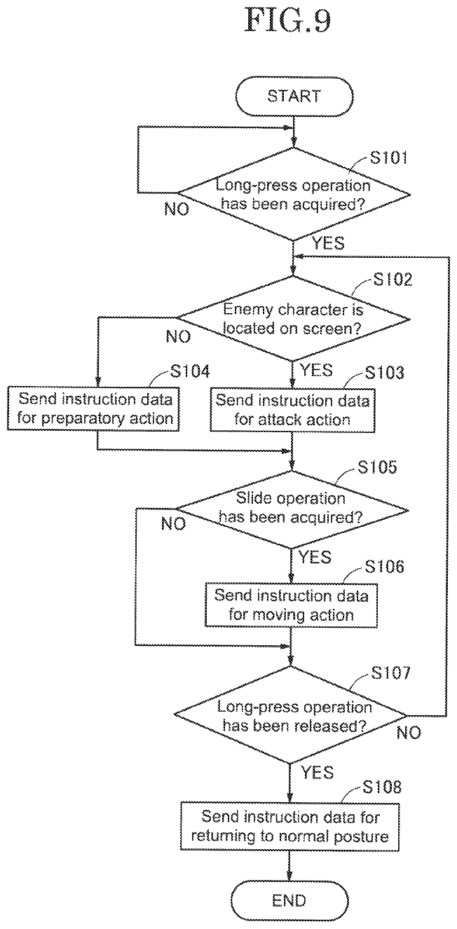

FIG. 9 is a flowchart for explaining the processing related to the attack action in the first embodiment. In this embodiment, the control part 21 of the server 200 executes the processing of the respective steps shown in FIG. 9. That is, the control part 21 reads the game program stored in the storage part 22 and executes the game program, thereby realizing each processing shown in FIG. 9.

When the game program is executed, the control part 21 judges whether the long-press operation has been performed on the operating area OA of the game screen GS displayed on the display part 13 of the communication device 100 (step S101). Specifically, when the control part 21 receives a signal indicating the input by the long-press operation from the communication device 100 (hereinafter, referred to as a “long-press operation signal”), if the coordinate information of the contact point CP included in the long-press operation signal is inside the operating area OA, the control part 21 judges that it has acquired the input by the long-press operation performed inside the operating area OA.

When the judgment result of Step S101 is NO, the processing by the control part 21 returns to Step S101. When the judgment result of Step S101 is YES, the control part 21 judges whether the enemy character image EC is located in the game screen GS (Step S102).

If the judgment result of Step S102 is YES, the control part 21 transmits instruction data for making the player character image PC execute the attack action to the communication device 100 in Step S103. The control part 11 of the communication device 100 generates display data of the player character image PC based on the received instruction data. Thereafter, as shown in FIG. 6, for example, the control part 11 displays the player character images PC for executing the attack action (shooting action) on the display part 13 based on the generated display data. If the judgment result of Step S102 is YES, instruction data for the preparatory action may be sent before sending instruction data for the attack action. That is, when the enemy character image EC is located in the game screen GS, the player character image PC may be controlled to execute the preparatory action once, and then immediately shift to the attack action.

When the judgment result of Step S102 is NO, the control part 21 transmits the instruction data for making the player character image PC execute the preparatory action of the attack action to the communication device 100 (Step S104). The control part 11 of the communication device 100 generates the display data of the player character image PC based on the received instruction data. Thereafter, as shown in FIG. 5, for example, the control part 11 displays the player character image PC in the preparatory action (shooting posture) on the display part 13 based on the generated display data.

After transmitting transmission data for the attack action or the preparatory action in Step S103 or Step S104, the control part 21 judges whether the slide operation is performed on the game screen GS (Step S105). Specifically, when the control part 21 receives a signal (hereinafter, referred to as a “slide operation signal”) indicating an input by the slide operation (specifically, the movement of the contact point CP) from the communication device 100, the control part 21 judges that the input by the slide operation has been acquired.

When the judgment result of Step S105 is YES, the control part 21 transmits instruction data for making the player character image PC execute the moving action to the communication device 100 (Step S106). Based on the received instruction data, as shown in FIG. 7, the control part 11 of the communication device 100 displays the player character image PC that moves in the direction indicated by the slide operation on the display part 13. When the judgment result of Step S105 is NO, the control part 21 proceeds to Step S107 without passing through Step S106.

Next, the control part 21 judges whether the long-press operation has been released (Step S107). Specifically, when the control part 21 receives a signal indicating that the long-press operation has been released (hereinafter referred to as a “long-press release signal”) from the communication device 100, the control part 21 judges that the input by releasing the long-press operation has been acquired.

When the judgment result of Step S107 is YES, the control part 21 transmits instruction data for returning the player character image PC to the normal posture to the communication device 100 (Step S108). The control part 11 of the communication device 100 cancels the shooting posture of the player character image PC based on the received instruction data, for example, as shown in FIG. 4. That is, the player character image PC returns to the normal posture without holding a gun. When the judgment result of Step S107 is NO, the processing by the control part 21 returns to Step S102.

As described above, in this embodiment, when the enemy character image EC is located in the game screen GS, the player character image PC executes the attack action on the enemy character image EC in response to the long-press operation of the user. However, when the enemy character image EC is not located in the game screen GS, the player character image PC only executes the preparatory action (i.e., shifts to the attack mode) in response to the user's long-press operation and does not execute the attack action.

When the enemy character image EC appears in the game screen GS while the player character image PC is executing the preparatory action, the player character image PC automatically executes the attack action on the enemy character image EC. On the contrary, when the enemy character image EC disappears from the game screen GS while the player character image PC is executing the attack action, the player character image PC automatically cancels the attack action.

As described above, in this embodiment, even if the player character image PC is in the attack posture by the user's long-press operation, when the enemy character image EC does not satisfy the predetermined condition (in this embodiment, the enemy character image EC is located in the game screen GS), the attack action by the player character image PC is not executed. In other words, the player character image PC executes the attack action on the enemy character image EC only when the enemy character image EC satisfies a predetermined condition. That is, according to this embodiment, it is possible to prevent the player character from executing the unnecessary attack action while maintaining the attack posture of the player character.

### Modification 1

In this embodiment, an example of judging whether the attack action is possible depending on whether the enemy character image EC is located in the game screen GS has been shown, but the present invention is not limited to this example. The game screen GS (i.e., the entire imaging range of the virtual camera) is an example of an attack area of the player character image PC, and the shape or size of the attack area can be set arbitrarily. In this embodiment, the “attack area” is an area that indicates the range in which the player character image PC executes the attack action. That is, in this embodiment, when the enemy character image EC is located inside the attack area, the player character image PC executes the attack action. For example, a circular area having a predetermined radius or a part of the circular area can be set in the game screen GS as the attack area.

### Modification 2

In this embodiment, the control part 21 of the server 200 executes the game programs to display the game screen GS on the display part 13 of the communication device 100. Therefore, if the communication state between the communication device 100 and the server 200 is unstable, it may be difficult to progress the game in real time.

For example, when the enemy character image EC appears on the game screen GS while executing the preparatory action, the player character image PC automatically executes the attack action. At this time, if the communication state is unstable, there may be a time lag in communication, and the attack of the player character image PC may not catch up with the movement of the enemy character image EC.

In such cases, the enemy character image EC or a collision detection area of the attack medium may be set to be larger than usual. The “collision detection area” is an area corresponding to a range for detecting that the objects are overlapped with each other on the screen. Typically, the collision detection area is substantially equal to an occupied area of the object (an area inside the outer shape of the object). That is, collision detection areas of substantially equal size to the occupied area of the enemy character image EC and the attack medium are set in the enemy character image EC and the attack medium, respectively, and when they overlap with each other, a collision (hit) is detected. That is, by setting the collision detection area of the enemy character image EC or the attack medium to be larger than usual, even if the attack medium does not hit the enemy character image EC, the game can be regarded as hit and the game can proceed.

In this manner, by setting the collision detection area of the enemy character image EC or the attack medium to be larger than usual, even if the communication state becomes unstable and a time lag occurs in the communication, it is possible to suppress the problem that the attack of the player character image PC cannot catch up with the movement of the enemy character image EC. For example, the collision detection area of the enemy character image EC for the attack medium may be larger than the occupied area of the enemy character image EC.

The setting of the above-mentioned collision detection area may be changed according to the communication state. For example, in a normal communication state (a first communication state), the collision detection area of the enemy character image EC or the attack medium is set to be substantially equal to the occupied area of the enemy character image EC or the attack medium. On the other hand, in a communication state (a second communication state) in which the communication speed is lower than the normal communication speed, the collision detection area of the enemy character image EC or the attack medium may be set to be larger than the occupied area of the enemy character image EC or the attack medium.

As described above, by setting the appropriate collision detection area according to the communication state, games can be enjoyed without feeling stress even in an environment where the communication state is unstable.

### Modification 3

In this embodiment, an example in which the player character image PC automatically cancels the attack action when the enemy character image EC disappears from the game screen GS while the player character image PC is executing the attack action has been shown, but the present invention is not limited to this example. For example, the player character image PC may be controlled to automatically track the enemy character image EC. Specifically, when the enemy character image EC moves to the transverse direction, the direction of the player character image PC may be changed according to the moving direction of the enemy character image EC.

According to this modification, since the imaging direction of the virtual camera is changed according to the movement of the enemy character image EC, the enemy character image EC can be continuously kept within the imaging range of the virtual camera (that is, within the game screen GS). Therefore, the player character image PC can continue the attack action while tracking the enemy character image EC. The imaging range of the virtual camera may be changed so that the enemy character image EC is always located substantially center of the game screen GS. The imaging range of the virtual camera may be changed so that when the enemy character image EC goes out of the game screen GS, the enemy character image EC is put in the game screen GS again.

### Second Embodiment

In the present embodiment, an example of judging whether the attack action is possible under a condition different from that of the first embodiment will be described. Specifically, an example in which the attack action is executed when the enemy character image EC is located within a predetermined distance from the player character image PC is shown. In the drawings used for the description of the present embodiment, the same elements as those of the first embodiment are denoted by the same reference numerals, and the description thereof is omitted.

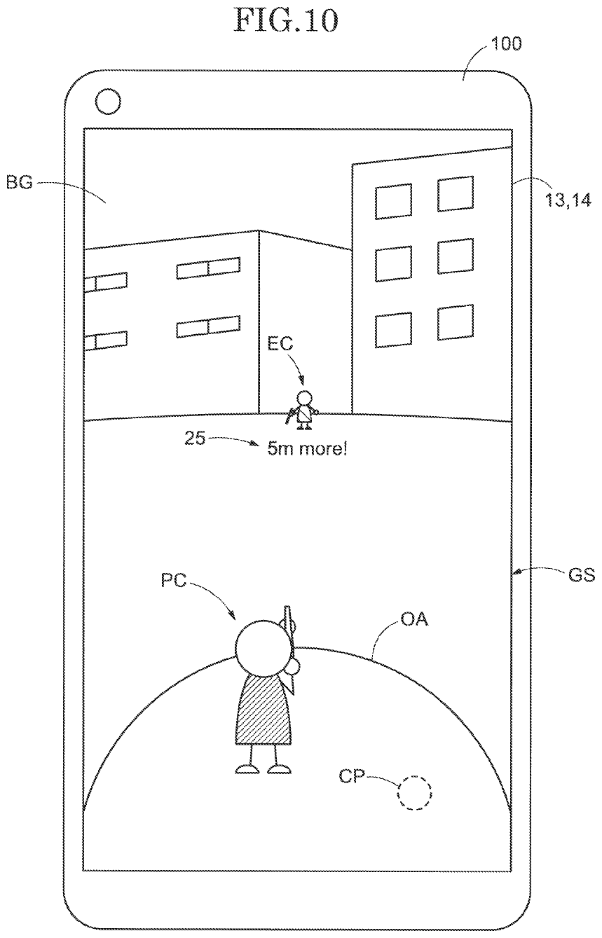

FIG. 10 is a diagram showing a state in which the long-press operation is performed on the game screen GS according to a second embodiment of the present invention. In FIG. 10, the player character image PC faces the enemy character image EC in a shooting posture with a gun. At this time, in the virtual space, the player character image PC and the enemy character image EC are separated from each other by exceeding a predetermined distance (for example, 20 m). Specifically, in FIG. 10, it is assumed that the player character image PC stands at a position 25 m away from the enemy character image EC.

As shown in FIG. 10, in this embodiment, even though the enemy character image EC is located in the game screen GS, the player character image PC does not execute the attack action on the enemy character image EC. Instead, in this embodiment, information 25 indicating that there is a factor that the player character image PC cannot attack the enemy character image EC is displayed. In the example shown in FIG. 10, a message “5 m more!” is displayed as the information 25 indicating that the distance is too far from the enemy character image EC.

If the player character image PC does not execute the attack action even though the enemy character image EC exists in the game screen GS, the user may not be able to understand what the cause is. On the other hand, in the present embodiment, by displaying the information 25, the user can be made to recognize that there is a factor that cannot attack the enemy character image EC (e.g., the reason that cannot attack the enemy character image EC).

As described above, in this embodiment, even if the enemy character image EC is located in the game screen GS, when the player character image PC is far from the enemy character image EC, the attack action is not executed. Specifically, in this embodiment, when the player character image PC is separated from the enemy character image EC by more than 20 m, the player character image PC does not attack the enemy character image EC. That is, even when a condition (a first condition) that the enemy character image EC is located in the game screen GS is satisfied, and when a condition (a second condition) that the player character image PC is separated from the enemy character image EC by more than 20 m is satisfied, the player character image PC is made to execute the preparatory action without executing the attack action.

On the other hand, when the player character image PC is located within 20 m of the enemy character image EC, the player character image PC performs the attack action on the enemy character image EC. As described above, in FIG. 10, since the player character image PC is 25 m away from the enemy character image EC, a message indicating that an attack will be possible if the player character image PC approaches 5 m closer is displayed as the information 25. Therefore, when the distance between the player character image PC and the enemy character image EC is reduced to 20 m or less by moving the player character image PC, the operation of the player character image PC shifts from the preparatory action to the attack action.

On the contrary, when the distance between the player character image PC and the enemy character image EC exceeds 20 m due to the movement of the enemy character image EC (when the second condition is satisfied), the operation of the player character image PC shifts from the attack action to the preparatory action. In this case, the information 25 indicating that the position of the player character image PC is too far from the enemy character image EC is displayed on the game screen GS.

As described above, in this embodiment, even when the enemy character image EC is located inside the attack area of the player character image PC (when the first condition is satisfied), if there is a factor that the player character image PC cannot attack the enemy character image EC (when the second condition is satisfied), the attack action is not executed by the player character image PC even if the user performs the long-press operation. In this case, the player character image PC performs the preparatory action of the attack action in response to the user's long-press operation. Further, in this embodiment, the information 25 indicating that there is a factor that the player character image PC cannot attack the enemy character image EC is displayed.

In this embodiment, as a factor that the player character image PC cannot attack the enemy character image EC, it is exemplified that the player character image PC and the enemy character image EC are separated from each other by a distance exceeding a predetermined distance in the virtual space. However, the above factor is not limited to this example. For example, as the above-mentioned factor, there may be a case in which the amount of the attack medium filled in the weapon becomes a predetermined amount or less, a case in which an object (for example, a buddy, an obstacle, or the like) that cannot be attacked exists between the player character image PC and the enemy character image EC, a case in which the enemy character image EC possesses an item that does not accept the attack or activates a skill, or a case in which the communication state between the communication device 100 and the server 200 is unstable.

In this embodiment, an example in which a message is displayed as the information 25 indicating that there is a factor that the player character image PC cannot attack the enemy character image EC has been shown. However, the information 25 is not limited to this example, and the presence of the above-mentioned factor may be notified to the user using a symbol, a figure, an image, a color, or the like. Furthermore, the presence of the above-described factor may be notified to the user by vibrating the housing using the function (specifically, the vibrator function) of the information part 20 of the communication device 100 or outputting sound using the function (specifically, the speaker function) of the sound input/output part 19.

### Third Embodiment

In this embodiment, an example in which the position at which the input by the long-press operation is started can be identified will be described. In the drawings used for the description of the present embodiment, the same elements as those of the first embodiment are denoted by the same reference numerals, and the description thereof is omitted.

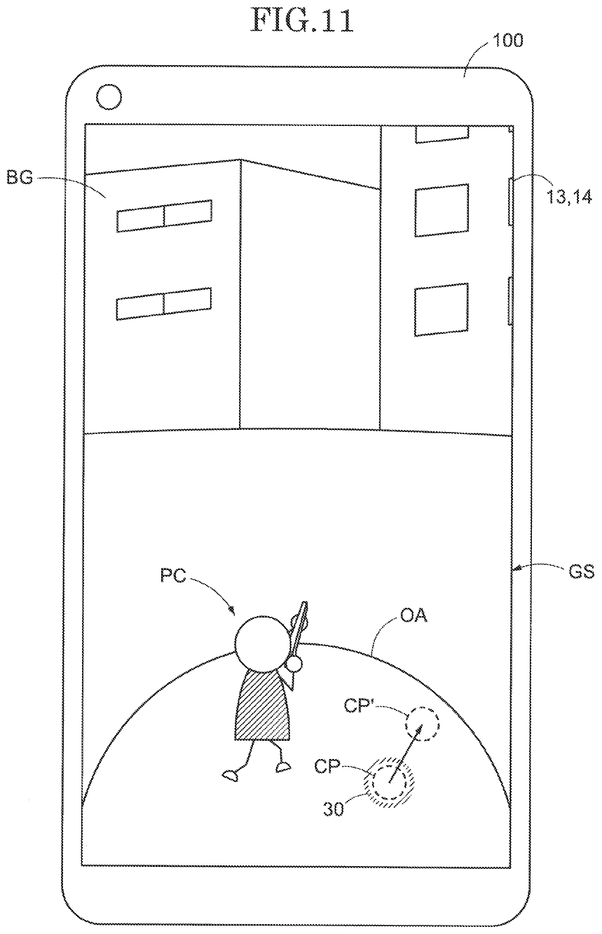

FIG. 11 is a diagram showing a state in which the slide operation is performed while the long-press operation is maintained in the game screen GS according to a third embodiment of the present invention. In this embodiment, an identification image 30 is displayed at the position of the contact point CP where the long-press operation by the user is started. The identification image 30 may be, for example, an image representing a circle surrounding the contact point CP, or may be an image in which the area corresponding to the contact point CP is colored with a color that can be distinguished from the background image BG. By displaying the identification image 30, the user can intuitively recognize at which position the input by the long-press operation is performed even if the position of the contact point CP is changed by the slide operation.

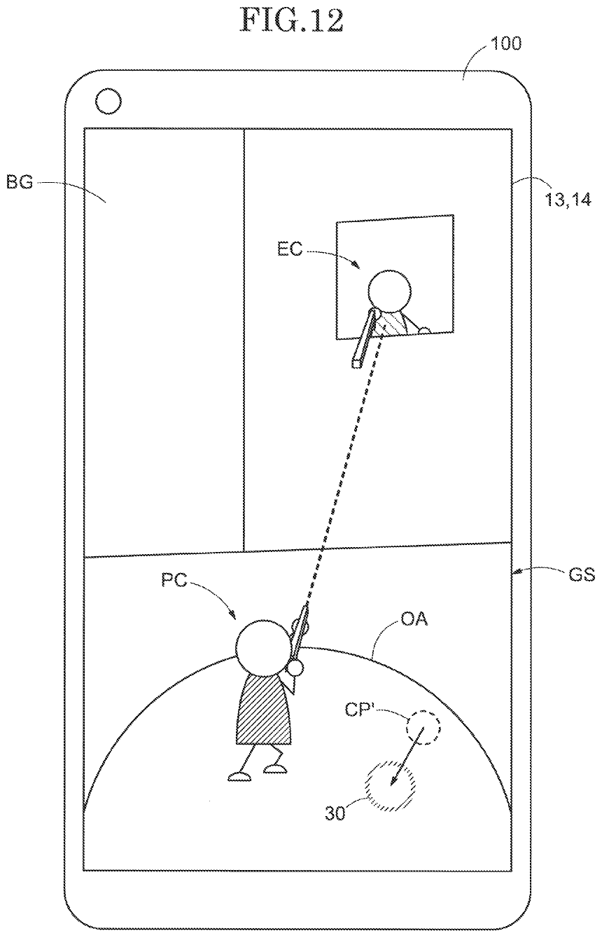

FIG. 12 is a diagram showing a state in which the player character image PC is stopped moving while maintaining the long-press operation on the game screen GS according to the third embodiment of the present invention. In this embodiment, to make the player character image PC execute the operation shown in FIG. 8, the user slides the finger from the contact point CP′ to the starting position of the long-press operation. In this case, in this embodiment, since the identification image 30 is displayed at the position where the long-press operation is started, the user can easily return the finger to the original position.

As described above, according to this embodiment, it is easy to return the user's finger to the position before the slide operation after the slide operation. As a result, in a game in which a player character is operated using a touch operation including a slide operation, operability can be improved.

### Fourth Embodiment

In this embodiment, an example of judging whether the attack action is possible under a condition different from that of the first embodiment will be described. Specifically, this example shows an example in which the attack action is executed when the enemy character image EC is overlapped with a sight region displayed on the game screen GS. In the drawings used for the description of this embodiment, the same elements as those of the first embodiment are denoted by the same reference numerals, and the description thereof is omitted.

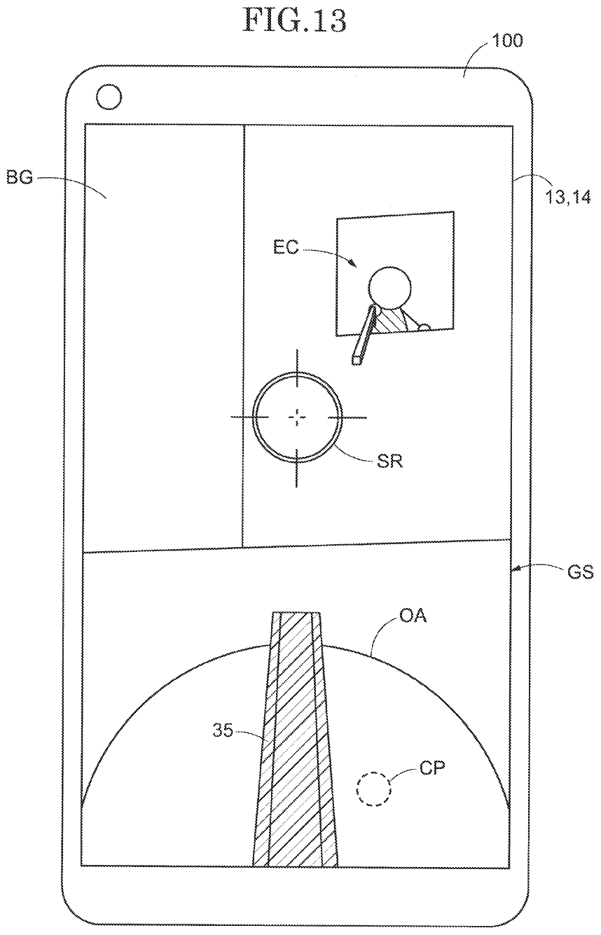

FIG. 13 is a diagram showing a state in which the long-press operation is performed on the game screen GS according to a fourth embodiment of the present invention. In this embodiment, when the player character image PC shifts to the preparatory action in response to the long-press operation, the game screen GS changes from a bird's-eye view screen (screen expressing a situation seen from behind the player character image PC) shown in FIG. 4 and the like to a scope screen (screen expressing a situation looking into a scope of a gun). As shown in FIG. 13, a sight region SR (gun-aimed area) is displayed in the vicinity of the center of the scope screen. At the bottom of the scope screen, a gun 35 held by the player character is displayed. However, when the scope screen is displayed, the user can intuitively recognize that the player character image PC has held the gun, and therefore the display of the gun 35 may be omitted.

In the state shown in FIG. 13, since the long-press operation is performed at the contact point CP, the player character has shifted to the attack mode. Although the enemy character image EC is displayed on the game screen GS (in FIG. 13, the scope screen), the sight region SR and the enemy character image EC are not overlapped with each other. Therefore, the player character does not perform the attack action on the enemy character image EC. That is, in this embodiment, overlapping the enemy character image EC on the sight region displayed on the game screen GS is a condition for the player character to shift from the preparatory action to the attack action.

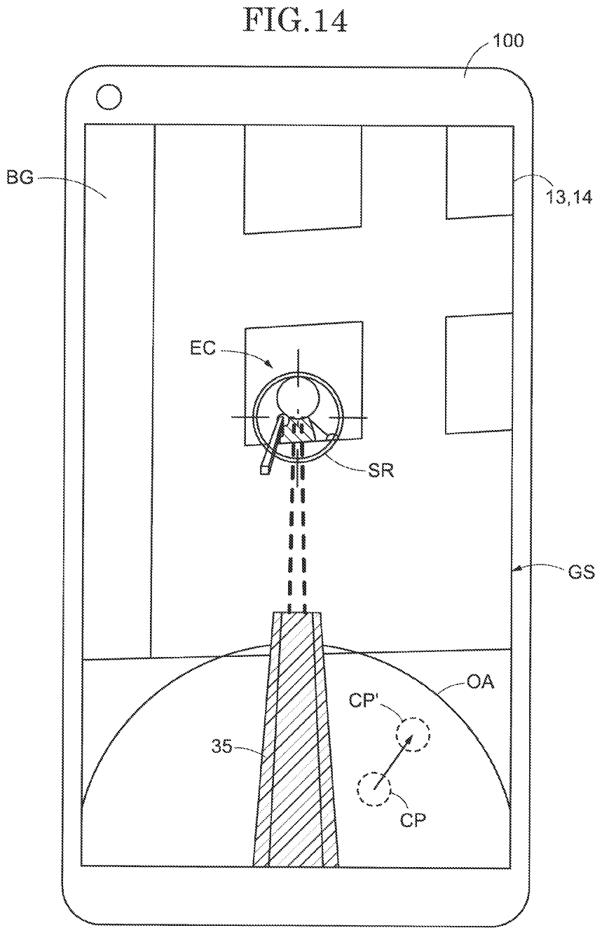

FIG. 14 is a diagram showing a state in which the sight region SR overlaps on the enemy character image EC in the game screen GS according to the fourth embodiment of the present invention. In the scope screen, when the slide operation is performed while maintaining the long-press operation, contents of the scope screen (specifically, a position in the virtual space of the sight region SR, which will be described later) changes. That is, in this embodiment, the sight region SR can be moved in any direction by the user performing the slide operation while the player character is executing the preparatory action.

FIG. 14 shows a state after the sight region SR is moved from the position shown in FIG. 13 to the position of the enemy character image EC by performing the slide operation from the contact point CP at which the long-press operation is started to the contact point CP′. As described above, when the slide operation is performed while the long-press operation is maintained and the sight region SR is overlapped on the enemy character image EC, the player character automatically executes the attack action.

According to this embodiment, when the player character shifts to the preparatory action of the attack action by the long-press operation, the game screen GS shifts to the scope screen, so that the user can intuitively recognize the transition to the preparatory action. By changing the game screen GS to the scope screen, the sense of realism of the game can be improved, and the sense of immersion of the user in the game world can be enhanced.

### Fifth Embodiment

In the first to fourth embodiments, in the game processing, an example in which the server 200 performs the processing of the operation executed by the object to be operated has been described. However, the present invention is not limited to this example, the processing of executing the operation of the object may be performed by the control part 11 of the communication device 100. In this case, the control part 11 of the communication device 100 carries out the acquisition of the operation input by the user and the execution of the operation executed by the object to be operated, and the server 200 may carry out a synchronization processing with other users.

As another example, the processing of executing the operation performed by the object may be performed as a distributed processing between the communication device 100 and the server 200.

While the present invention has been described with reference to the accompanying drawings, the present invention is not limited to the each of the foregoing embodiments, and can be appropriately modified without departing from the spirit of the present invention. For example, as long as the gist of the present invention is provided, it is within the scope of the present invention to add, delete, or change the design of components as appropriate by a person skilled in the art based on each embodiment including variations. Further, the above-described embodiments can be appropriately combined as long as there is no mutual inconsistency, and technical matters common to the embodiments are included in the embodiments even if they are not explicitly described.

It is to be understood that other working effects different from those provided by the aspects of the respective embodiments described above, or those which can be easily predicted by those skilled in the art from the description herein, are naturally brought about by the present invention.

What is clamed is:

1. A game control method comprising:
making a first object to be operated perform a preparatory action for an attack action, triggered by an input from a long press operation on a screen; and
making the first object perform the attack action against a second object when the second object to be attacked satisfies a first condition while the first object is performing the preparatory action.

2. The game control method according to claim 1, further comprising:
making the first object move in a direction indicated by a slide operation maintaining the preparatory action when an input from a slide operation against the screen is acquired while the first object is performing the preparatory action.

3. The game control method according to claim 1, wherein the first condition is that the second object is located inside an attack area of the first object.

4. The game control method according to claim 1, wherein the first condition is that the second object overlaps a sight region displayed on the screen.

5. The game control method according to claim 1, further comprising:
making the first object perform the preparatory action without making the first object perform the attack action when the second object satisfies the first condition and the first object satisfies a second condition.

6. The game control method according to claim 1, further comprising:
displaying, on the screen, information indicating that the second condition is satisfied when the first object satisfies the second condition.

7. The game control method according to claim 5, wherein the second condition is that there is a factor preventing the first object from attacking the second object.

8. The game control method according to claim 5, wherein the second condition is that the first object and the second object are separated by more than a predetermined distance.

9. The game control method according to claim 1, further comprising:
shifting the action of the first object from the attack action to the preparatory action when the first object satisfies the second condition while the first object is performing the attack action.

10. The game control method according to claim 9, further comprising:
displaying, on the screen, information indicating that the second condition is satisfied when the first object satisfies the second condition.

11. The game control method according to claim 9, wherein the second condition is that there is a factor preventing the first object from attacking the second object.

12. The game control method according to claim 9, wherein the second condition is that the first object and the second object are separated by more than a predetermined distance.

13. The game control method according to claim 1, wherein the preparatory action is holding a weapon, and
the attack action is an action of releasing an attack medium from the weapon.

14. The game control method according to claim 13, wherein a collision detection area of the second object against the attack medium is larger than an occupied area of the second object.

15. The game control method according to claim 13, wherein a collision detection area of the second object against the attack medium is approximately equal to an occupied area of the second object in a first communication state, and larger than the occupied area of the second object in a second communication state with a communication speed lower than the first communication state.

16. The game control method according to claim 1, further comprising:
displaying an identification image on a position of a contact point where the long press operation was initiated in response to an input by the long press operation.

17. A computer-readable storage medium storing a program for causing a control part of a server to execute the game control method according to claim 1.

18. A computer-readable storage medium storing a program for causing a control part of a communication device to execute the game control method according to claim 1.

19. A server including a control part for executing the game control method according to claim 1.

20. A communication device including a control part for executing the game control method according to claim 1.
